(19) United States
(12) Patent Application Publication
(10) Pub. No.: US 2014/0255090 A1
(43) Pub. Date: Sep. 11, 2014

(54) CLAMP WITH ACTUATOR OPERATED LOCKING MECHANISM

(71) Applicant: DAVIS-STANDARD, LLC, Pawcatuck, CT (US)

(72) Inventors: Thomas J. Oravits, Durham, CT (US); Jeffrey S. Bryan, Voluntown, CT (US)

(73) Assignee: DAVIS-STANDARD, LLC, Pawcatuck, CT (US)

(21) Appl. No.: 14/193,969

(22) Filed: Feb. 28, 2014

Related U.S. Application Data
(60) Provisional application No. 61/772,851, filed on Mar. 5, 2013.

(51) Int. Cl. F16B 2/10

(52) U.S. Cl. CPC F16B 2/10
USPC 403/338

(57) ABSTRACT

A clamp for removably securing flanges to one another includes a first clamp member having a first pivot connection positioned proximate one end thereof and an abutment portion positioned proximate an opposing end thereof, the first clamp member being configured to extend partially around the flanges. The clamp includes a second clamp member having a second pivot connection positioned proximate one end thereof and a locking assembly positioned proximate an opposing end thereof, the second clamp member being configured to extend partially around the flanges. The clamp includes a linkage pivotally connected to the first pivot connection and to the second pivot connection, such that the first clamp member is movable relative to the second clamp member and the linkage. The locking assembly includes an actuator secured to the second clamp member and having a shaft which has a locking arm secured thereto. The shaft and locking arm are movable in relation to the actuator, along a longitudinal axis of the shaft and rotatable around the longitudinal axis. The locking arm is selectively engagable with the abutment portion to releasably lock the first clamp member to the second clamp member.

### CROSS REFERENCE TO RELATED APPLICATIONS

This application claims priority to U.S. Provisional Patent Application Ser. No. 61/772,851, entitled “Clamp With Actuator Operated Locking Mechanism,” and filed Mar. 5, 2013, the subject matter of which is incorporated herein by reference.

### FIELD OF THE INVENTION

The present invention relates to the field of clamps for coupling flanges to one another and in particular to a clamp having a locking mechanism that is actuated by an actuator having a shaft which moves in and out of the actuator along a longitudinal axis and rotates around the axis.

### BACKGROUND OF THE INVENTION

There are many types of devices that can be used to removably couple two sections of pipe to one another or to removably secure two sections of a machine to one another. For example, a flange can be positioned on an end of a pipe or machine and coupled to another flange by a plurality of threaded fasteners such as bolts and nuts. However, installation and removal of such flanged couplings can be time consuming and labor intensive.

One such machine that utilizes flanged couplings is an extrusion device. Extrusion devices are used to melt, blend, and form materials, such as plastics, into a desired shape. Typical extrusion devices include a rotating screw housed coaxially within a heated, cylindrically-shaped feed throat and barrel. A portion of the feed throat is cut away thereby forming an opening for admission of materials. A hopper is coupled to the extrusion device for feeding the material through the opening, into the feed throat and subsequently into the barrel. The screw rotates within the feed throat and barrel and drives the material therethrough. The extrusion material is forced through a die or aperture at a discharge end of the barrel. A flange is mounted on the discharge end of the barrel for connection to a mating flange of a pipe, a film casting apparatus, a die or other device for processing the extrusion material. The flange on the discharge end of the barrel is coupled to the other flange with a coupling or clamp.

### SUMMARY OF THE INVENTION

According to aspects illustrated herein, there is provided a clamp for removably securing flanges to one another. The clamp includes a first clamp member having a first pivot connection positioned proximate one end thereof and an abutment portion positioned proximate an opposing end thereof. The first clamp member is configured to extend partially around the flanges. The clamp includes a second clamp member having a second pivot connection positioned proximate one end thereof and a locking assembly positioned proximate an opposing end thereof. The second clamp member is configured to extend partially around the flanges. The clamp includes a linkage pivotally connected to the first pivot connection and to the second pivot connection, such that the first clamp member is movable relative to the second clamp member and the linkage. The locking assembly includes an actuator secured to the second clamp member and having a shaft which has a locking arm secured thereto. The shaft and locking arm are movable in relation to the actuator, along a longitudinal axis of the shaft and rotatable around the longitudinal axis. The locking arm is selectively engagable with the abutment portion to releasably lock the first clamp member to the second clamp member.

### BRIEF DESCRIPTION OF THE DRAWINGS

FIG. 1 is a front elevation view of a clamp of the present invention shown in a locked closed position;

FIG. 2 is a perspective view of a right side of the clamp of FIG. 1;

FIG. 3 is a perspective view of a left side of the clamp of FIG. 1;

FIG. 4 is a front elevation view of the clamp shown in an open position;

FIG. 5 is a perspective view of a right side of the of the clamp of FIG. 4;

FIG. 6 is a perspective view of the clamp of FIG. 4 shown with the locking bar in a locked position;

FIG. 7 is a perspective view of the clamp of FIG. 1 shown with the locking arm in a released position;

FIG. 8 is a perspective view of the clamp of FIG. 4; and

FIG. 9 is a cross sectional view of the actuator of FIG. 1.

### DETAILED DESCRIPTION OF THE INVENTION

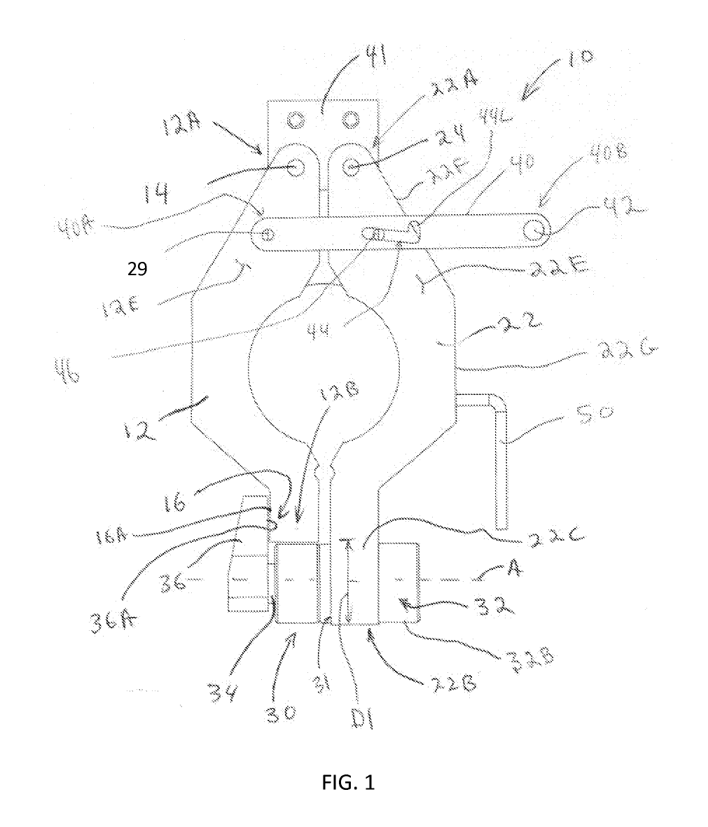

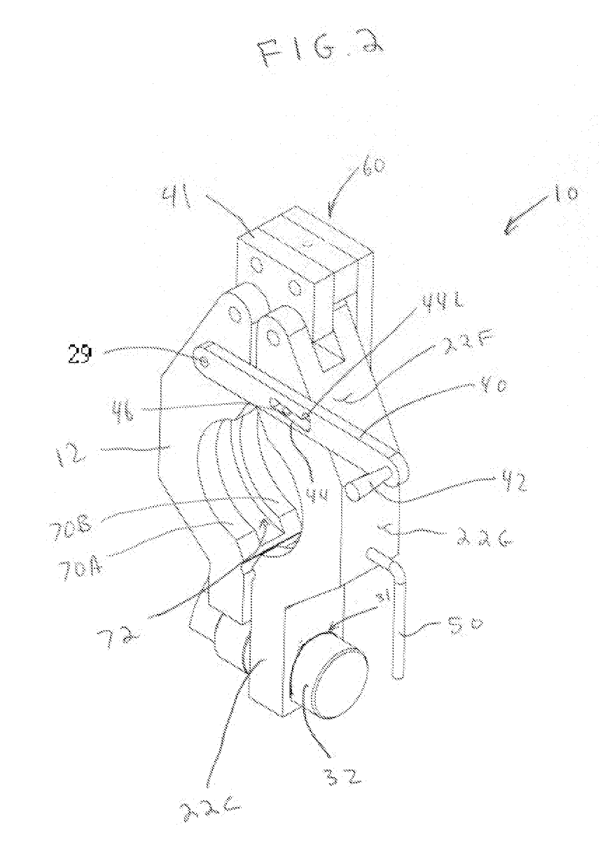

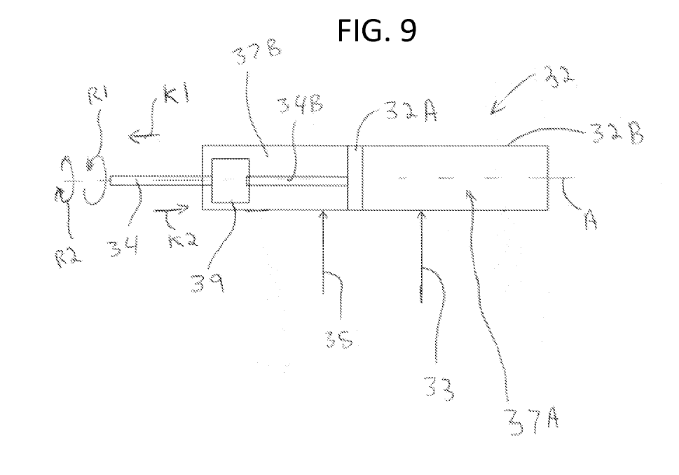

In reference to FIGS. 1 and 2, a clamp 10 for removably securing flanges (not shown) to one another, such as securing a discharge flange of an extrusion machine to a pipe flange. The clamp 10 includes a first clamp member 12 having a first pivot connection 14 positioned proximate one end 12A thereof and an abutment portion 16 positioned proximate an opposing end 12B thereof. The first clamp member 12 is configured to extend partially around the flanges, for example in a C-shaped configuration that extends about 180 degrees around the flanges. The clamp 10 includes a second clamp member 22 having a second pivot connection 24 positioned proximate one end 22A thereof and a locking assembly 30 positioned proximate an opposing end 22B thereof. The opposing end 22B extends a distance D1 beyond an edge of the end 12B of the first clamp member 12. The second clamp member 22 is configured to extend partially around the flanges, for example, in a C-shaped configuration that extends about 180 degrees around the flanges. The clamp 10 includes a linkage 41 pivotally connected to the first pivot 14 connection and to the second pivot connection 24, such that the first clamp member 12 is movable relative to the second clamp member 24 and the linkage 41. The locking assembly 30 includes an actuator 32, for example, a piston 32A (see FIG. 9 for the piston) and cylinder 32B type actuator secured to the second clamp member 22. In one embodiment, the cylinder 32B is threaded into a bore 31 extending through an extended flat section 22C of the second clamp member 22. The actuator 32 includes a shaft 34 which has a locking arm 36 secured thereto. The shaft 34 and locking arm 36 are movable in relation to the cylinder 32B, along a longitudinal axis A of the shaft 32 and is rotatable around the longitudinal axis A, as described further herein. An engagement surface 36A of the locking arm 36 is selectively engagable with an outward facing surface 16A of the abutment portion 16 to releasably lock the first clamp member 12 to the second clamp member 22.

While the first clamp member 12 and the second clamp member 22 are shown and described as single pieces, the present invention is not limited in this regard, as the two clamp members 12 and 22 may include two hinged pieces. Although the actuator 32 is described as being a piston 32A and cylinder 32B type actuator the present invention is not limited in this regard as any type of actuator that has a shaft 34 and locking arm 36 that are movable in relation to the cylinder 32B, along a longitudinal axis A of the shaft 32 and is rotatable around the longitudinal axis A, such as but not limited to a pneumatic operated or motor operated actuator, may be employed without departing from the broader aspects disclosed herein.

As illustrated in FIGS. 1 and 2, a locking bar 40 has one end 40A pivotally connected to an end face 12E of the first clamp member 12 via a pin 29. Another end 40B of the locking bar 40 extends over an end face 22E of the second locking member 22 and extends past an edge 22F of the second locking member 22. A handle 42 is positioned proximate the other end 40B of the locking bar 40. A longitudinal slot 44 extends through the locking bar 40. The longitudinal slot 44 is L-shaped and has a leg 44L extending traversely from an end of the slot closer to the other end 40B of the locking bar 40. The leg extends traversely from the slot at an angle of about ninety degrees. A pin 46 (e.g., a shoulder bolt) is secured to the end face 22E of the second clamp member 22. The pin 46 extends through the slot 44. The pin 46 slideably moves in the slot 44 and leg 44L when the clamp 10 is operated between a closed or clamped position and an open position, as described below.

While the locking bar 40 is described and shown as being pivotally connected to the first clamp member 12 and the pin 46 extending from the second clamp member 22 and through the slot 44, the present invention is not limited in this regard as the locking bar may be pivotally connected to the second clamp member 22 and the pin 46 may be positioned in the first clamp member 12 and extend into the slot 44.

As illustrated in FIGS. 1 and 2, the clamp 10 includes a handle 50, for example an L-shaped handled positioned on an edge 22G of the second clamp member 22, for use by an operator to operate the clamp 10 between a closed or clamped position and an open position, as described below.

Referring to FIG. 2, a mounting bracket 60 is secured to the linkage 41 for mounting the clamp 10 to a machine, for example to an extrusion machine.

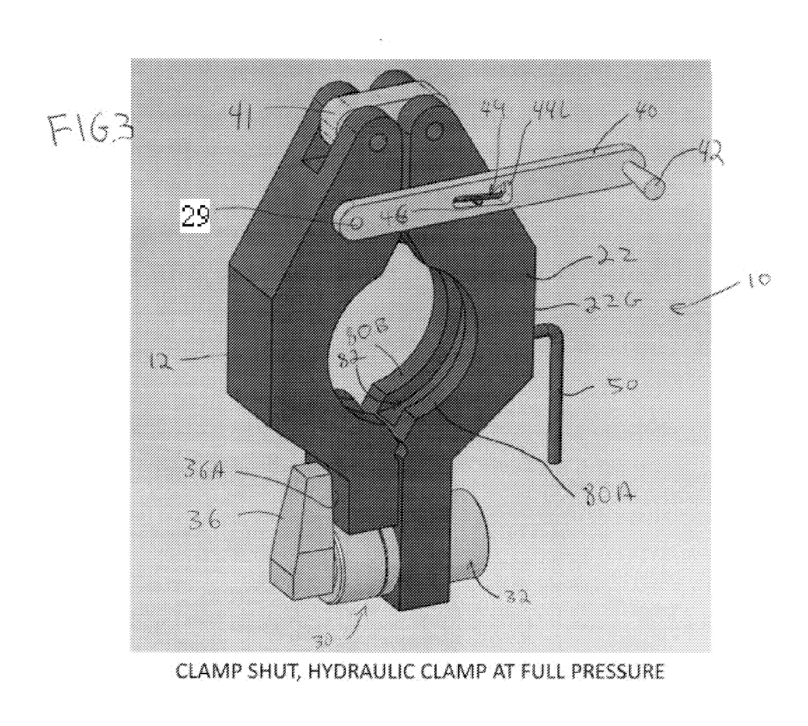

Referring to FIG. 2, the first clamp member 12 defines a radially inwardly facing C-shaped interior surface defined by a first lip 70A and a second lip 70B and a groove 72 formed therebetween for receiving a peripheral portion of the flanges. Referring to FIG. 3, the second clamp member 22 defines a radially inwardly facing C-shaped interior surface defined by a first lip 80A and a second lip 80B and a groove 82 formed therebetween for receiving a peripheral portion of the flanges.

As shown in FIG. 9, the cylinder 32B includes a first chamber 37A on one side of the piston 32A and a second chamber 37B on an opposite side of the piston 32A. A supply line 33 is in fluid communication with the first chamber 37A and another supply line 35 is in fluid communication with the second chamber 37B. The supply line 33 is configured to supply a fluid, such as a pressurized hydraulic fluid to the first chamber 37A to cause the piston 32A to move in the direction indicated by the arrow K1. The supply line 35 is configured to supply a fluid, such as a pressurized hydraulic fluid to the second chamber 37B to cause the piston 32A to move in the direction indicated by the arrow K2.

As shown in FIG. 3, the clamp 10 is shown in the locked or clamped position in which the engagement surface 36A (as shown in FIG. 1) of the locking arm 36 to is positioned over and clampingly engages the outward facing surface 16A (as shown if FIG. 1) of the abutment portion 16. The clamp 10 is maintained in the locked position by pressurizing the second chamber 37B with pressurized fluid (e.g., hydraulic fluid) supplied through the supply line 35.

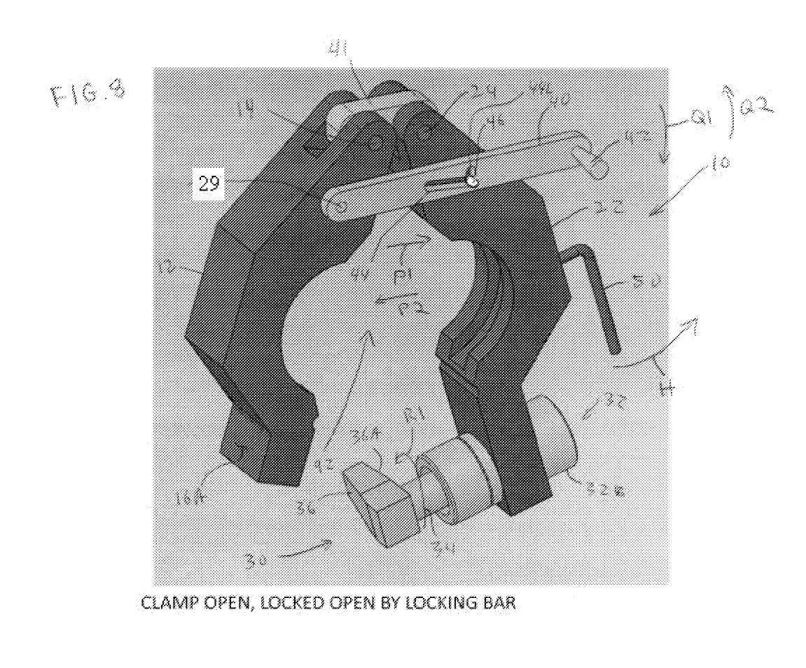

As shown in FIG. 7, the clamp 10 is shown in a released position in which the locking arm 36 is axially extended and rotated away from the abutment portion 16 thereby allowing the first clamp member 12 and the second clamp member 22 to be rotated away from each other into the released position, as described below. Referring to FIG. 9, the locking arm 36 is axially extended and rotated away from the abutment portion 16 by pressurizing the first chamber 37A with pressurized fluid (e.g., hydraulic fluid) supplied through the supply line 33.

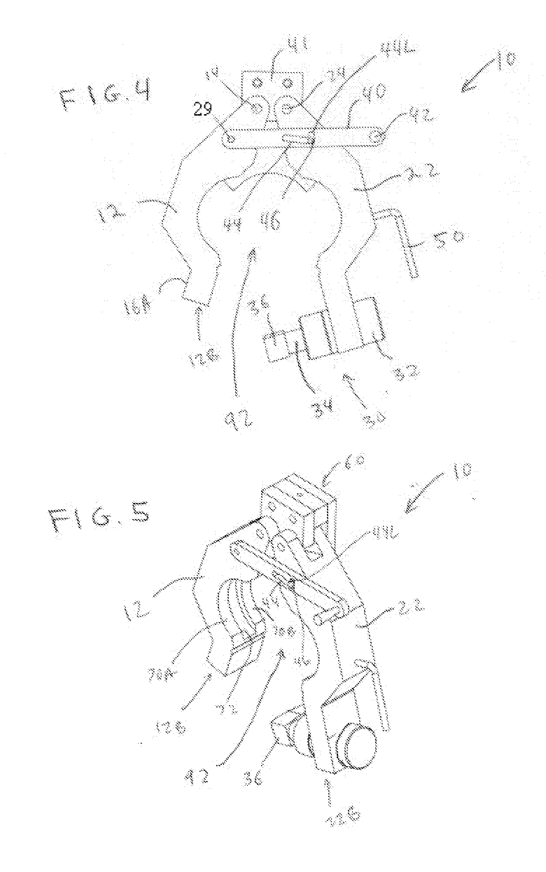

As illustrated in FIGS. 4, 5 and 8, the first clamp member 12 and the second clamp member 22 are rotated away from each other into an open position thereby defining an opening 92 therebetween. The opening 92 is sized and configured to release the flanges therefrom. A force is applied to the handle 50 in the direction of the arrow H to move the second clamp member 22 away from the first clamp member 12. When the second clamp member 22 is moved away from the first clamp member 12, the pin 46 slides in the slot 44 in the direction indicated by the arrow P1 until the pin 46 engages an end of the slot adjacent to the leg 44L. The clamp 10 is held in the open position by moving the locking bar 40 in the direction indicated by the arrow Q1, thereby causing the pin 46 to seat in the leg 44L.

To move the first clamp member 12 and the second clamp member 22 to the locked position as shown in FIG. 3, the locking bar 40 is moved in the direction indicated by the arrow Q2 to disengage the pin 46 from the leg 44L thereby allowing the pin 46 to slide in the slot 44 away from the leg 44L in the direction indicated by the arrow P2.

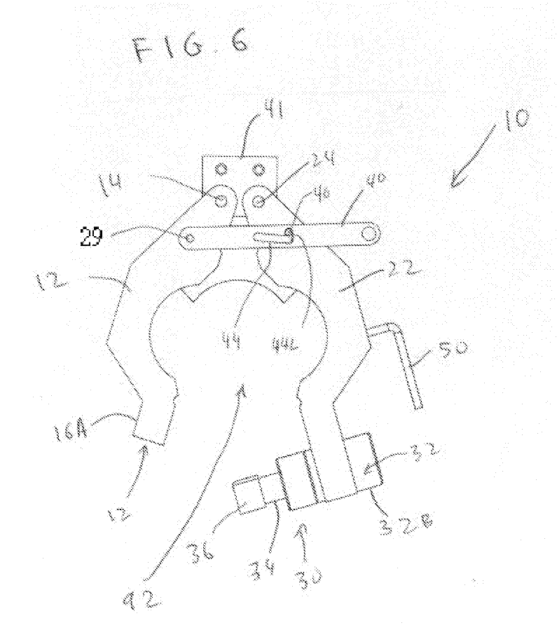

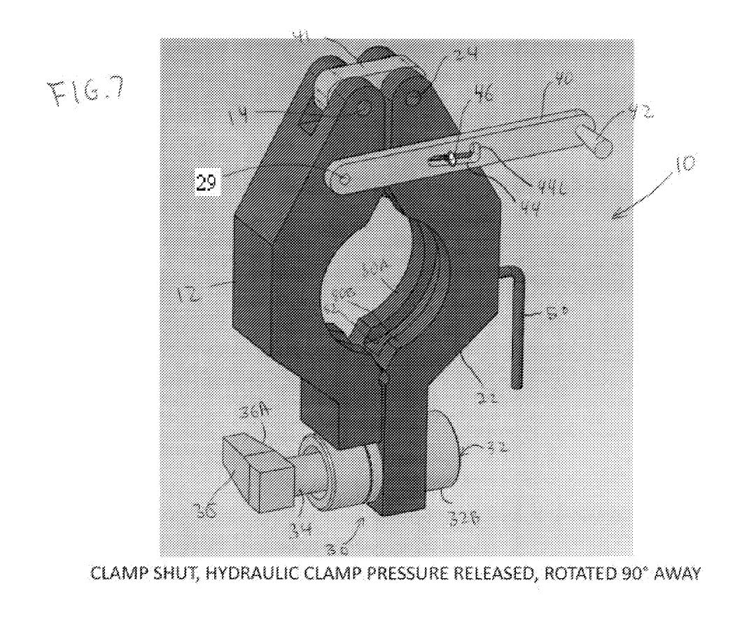

As shown in FIG. 9 the actuator 32 includes the piston 32A slideably positioned in an interior area defined by the cylinder 32B. The shaft 34 extends out of the cylinder 32B and is operatively connected to a linear-to-rotational motion converter 39. A second shaft 34B is secured to the piston 32A and engages the linear-to-rotational motion converter 39. Movement of the piston 32A towards the linear-to-rotational motion converter 39 causes the locking assembly 30 to arrive at a released position as illustrated in FIGS. 5 and 6. For example, the movement of the piston 32A towards the linear-to-rotational motion converter 39 causes the second shaft 34B to move into the linear-to-rotational motion converter 39 in the direction of the arrow K1 and causes the shaft 34 to move an initial distance in the direction of the arrow K1. Movement of the shaft 34 the initial distance releases the engagement of the engagement surface 36A (as shown in FIG. 1) of the locking arm 36 with the outward facing surface 16A of the abutment portion 16. Further movement of the second shaft 34B into the linear-to-rotational motion converter 39 in the direction of the arrow K1 causes the shaft 34 to move a further distance in the direction of the arrow K1 while causing the shaft 34 to rotate in the direction of the arrow R1, for example, causes the shaft to rotate a quarter turn (i.e., 90 degrees). Rotation of the shaft 34 a quarter turn causes the locking arm 36 to swing clear of the outward facing surface 16A of the abutment portion 16, thereby allowing the first clamp member 12 and the second clamp member 22 to be rotated away from each other into the open position.

Movement of the piston 32A away from the linear-to-rotational motion converter 39 causes the locking assembly 30 to arrive at a locked or clamped position as illustrated in FIGS. 1 and 3. For example, the movement of the piston 32A away from the linear-to-rotational motion converter 39 causes the second shaft 34B to move away from the linear-to-rotational motion converter 39 in the direction of the arrow K2 causes the shaft 34 to move a distance in the direction of the arrow K2. Initial movement of the shaft 34 in the direction of the arrow K2 causes the shaft 34 to rotate in the direction of the arrow R2, for example, causes the shaft to rotate a quarter turn (i.e., 90 degrees) while causing the engagement surface 36A of the locking arm 36 to move towards and over the outward facing surface 16A of the abutment portion 16. Further movement of the second shaft 34B away from the linear-to-rotational motion converter 39 in the direction of the arrow K2 causes the shaft 34 to move a further distance in the direction of the arrow K2 thereby causing a clamping engagement of the engagement surface 36A of the locking arm 36 and the outward facing surface 16A of the abutment portion 16.

Although the present invention has been disclosed and described with reference to certain embodiments thereof, it should be noted that other variations and modifications may be made, and it is intended that the following claims cover the variations and modifications within the true scope of the invention.

What is claimed is:

1. A clamp for removably securing flanges to one another, the clamp comprising:
a first clamp member having a first pivot connection positioned proximate one end thereof and an abutment portion positioned proximate an opposing end thereof, the first clamp member being configured to extend partially around the flanges;
a second clamp member having a second pivot connection positioned proximate one end thereof and a locking assembly positioned proximate an opposing end thereof, the second clamp member being configured to extend partially around the flanges;
a linkage pivotally connected to the first pivot connection and to the second pivot connection, such that the first clamp member is movable relative to the second clamp member and the linkage;
the locking assembly comprising an actuator secured to the second clamp member and having a shaft having locking arm secured thereto, the shaft and locking arm being movable in relation to the actuator, along a longitudinal axis of the shaft and rotatable around the longitudinal axis; and
the locking arm being selectively engagable with the abutment portion to releasably lock the first clamp member to the second clamp member.

2. The clamp of claim 1, wherein the locking assembly defines a locked position in which the locking arm is positioned over and engages the abutment portion such that the first clamp member is locked to the second clamp member.

3. The clamp of claim 1, wherein the locking assembly defines a released position in which the locking arm is rotated away from the abutment portion.

4. The clamp of claim 3, wherein the locking arm is spaced apart from the abutment portion.

5. The clamp of claim 1, wherein in an open position the first clamp member is rotated away from the second clamp member defining an opening therebetween, the opening being configured to release the flanges therefrom.

6. The clamp of claim 1, further comprising a locking bar pivotally connected to the first clamp member, the locking bar having a longitudinal slot extending therethrough and the second clamp member having a pin extending therefrom and slidingly positioned in the slot.

7. The clamp of claim 6, wherein the slot includes a traverse portion for receiving the pin therein and releasably locking the first clamp member in an open position when the first clamp member and the second clamp member are rotated away from one another.

8. The clamp of claim 1, further comprising a locking bar pivotally connected to the second clamp member, the locking bar having a longitudinal slot extending therethrough and the first clamp member having a pin extending therefrom and slidingly positioned in the slot.

9. The clamp of claim 8, wherein the slot includes a traverse portion for receiving the pin therein and releasably locking the second clamp member in a released position when the first clamp member and the second clamp member are rotated away from one another.

10. The clamp of claim 1, further comprising a handle positioned on at least one of the first clamp member and the second clamp member.

11. The clamp of claim 1, further comprising a piston mounted on the shaft and positioned in the cylinder, a first fluid in communication with a first side of the piston for causing the shaft to extend out of and rotate relative to the cylinder.

12. The clamp of claim 1, further comprising a piston mounted on the shaft and positioned in the cylinder, a second fluid in communication with a second side of the piston for causing the shaft to retract into and rotate relative to the cylinder.

13. The clamp of claim 1, further comprising a mounting bracket secured to the linkage.

14. The clamp of claim 1 wherein each of the first clamp member and the second clamp member define two radially inward extending lips defining a groove therebetween, the groove being configured to receive and releasably secure the flanges to one another.

15. The clamp of claim 11, wherein the clamp is maintained in a released position via a pressurized fluid.

16. The clamp of claim 12, wherein the clamp is maintained in a locked position via a pressurized fluid.
